(19) United States
(12) Patent Application Publication
(10) Pub. No.: US 2015/0373822 A1
(43) Pub. Date: Dec. 24, 2015

(54) APPARATUS AND METHOD FOR RADIOGRAPHIC INSPECTION OF UNDERWATER OBJECTS

(71) Applicants: BP EXPLORATION OPERATING COMPANY LIMITED, Middlesex (GB); JME LIMITED, Suffolk (GB)

(72) Inventors: Mark Churchman, Suffolk (GB); Gareth JINKERSON, Suffolk (GB); Danny Lee KECK, Houston, TX (US); Thomas KNOX, Middlesex (GB); Graham Anthony OPENSHAW, Portsmouth, NH (US)

(21) Appl. No.: 14/649,574

(22) PCT Filed: Dec. 4, 2013
(86) PCT No.: PCT/EP2013/075502

§ 371 Date: Jun. 4, 2015

Related U.S. Application Data
(60) Provisional application No. 61/733,107, filed on Dec. 4, 2012.

(30) Foreign Application Priority Data
Mar. 6, 2013 (EP) 13158044.1

(51) Int. Cl. H05G 1/20; H05G 1/56; G01N 23/18; G01N 23/04; G01N 23/083

(52) U.S. Cl. CPC H05G 1/20; G01N 23/04; G01N 23/083; G01N 23/18; H05G 1/56

(57) ABSTRACT

According to the present invention there is provided an apparatus for radiographic inspection of an underwater object comprising: an x-ray source for generating an x-ray beam for directing at an object under inspection; and a power supply, for supplying electrical power to the x-ray source; wherein the x-ray source comprises a circular-path particle accelerator, which circular-path particle accelerator comprises a circular-path particle chamber and an electromagnetic accelerator for accelerating electrons within the chamber, and the power supply comprises at least one solid state capacitor for providing an alternating discharge current to drive the electromagnetic accelerator in the x-ray source. There is also provided a method for the radiographic inspection of an underwater object.

The present invention relates to an apparatus and method for radiographic inspection of underwater objects. In particular, the present invention relates to an apparatus and method for radiographic inspection of underwater objects, which method employs a source of high energy x-rays wherein the source comprises a circular-path particle accelerator.

The basic principles of radiography are well-understood. Positioning an object of interest between an electromagnetic radiation source and a detector causes a portion of the radiation emitted from the source to be absorbed by the object and a portion to pass through the object, due to variations in density and composition of the object of interest. Electromagnetic radiation that is not absorbed by the object of interest may be captured by the detector, forming an image on the detector. The resulting image may then be processed and enhanced by various means.

A very common application of radiography is in the medical field where it is used to allow physicians to visually observe the condition of bones and other features internal to a patient's body. Various types of radiation may be used in radiography, including x-rays and gamma rays, depending on the application. Because of its ability to create representations of the internal components of an object, industrial radiography has been employed in the analysis and non-destructive inspection of engineered structures, machines and other man-made products. For instance, industrial radiography may be used in testing and inspecting plate metal, pipe walls and welds on pressure vessels and on piping components.

Underwater pipelines, cables and structures associated with oil and gas fields, such as production wells or injection wells may require non-destructive inspection, for example, to detect any erosion or corrosion. These objects may be located at the sea floor, which may be up to 10,000 feet (3048 metres) below the surface, wherein the hydrostatic pressure of the water may exceed 4,460 pounds per square inch (PSI).

Known underwater radiographic inspection techniques include the use of gamma radio-isotope sources. However, such techniques are limited in that the gamma rays produced cannot penetrate objects having a steel equivalent thickness of greater than 90 mm. Steel equivalent thickness for a material having a particular thickness X means the thickness of steel Y that would result in the same attenuation of electromagnetic radiation had it passed through the material with the thickness X. Materials that attenuate more than steel would thus have a greater steel equivalent thickness than their actual thickness, whereas materials that attenuate less than steel would have less steel equivalent thickness than their actual thickness.

Thus, such techniques may not be capable of inspecting many underwater structures, for example submarine pipelines located in deep water, which may have a steel equivalent thickness in the range 150 mm to 200 mm. Whilst higher energy isotope sources are available, these are not licensed for use in a sub-marine environment. In addition, the use of radio-isotopes in a marine environment is limited to a water depth of 609 m due to regulations with respect to the use of isotope projector devices.

Accordingly, there remains a need for an apparatus and method for conducting non-destructive inspection of underwater objects, which is capable of inspecting objects having a steel equivalent thickness of greater than 90 mm and/or being employed in deep water. By “deep water” it is meant a body of water having a depth of greater than approximately 610 m.

OMAE2004-51599, Proceedings of OMAE04 23rd International Conference on Offshore Mechanics and Artic Engineering, Jun. 20-25, 2004 discusses the possibility of employing a linear particle accelerator as a high energy x-ray source for the non-destructive inspection of sub-sea flexible risers.

It has now been found that a source of high energy x-rays comprising a circular-path particle accelerator may be employed for the non-destructive inspection of underwater objects.

Particle accelerators are devices which use electromagnetic fields to propel charged particles to high velocities and to contain them in well-defined beams. As the acceleration of the particles increases, the energy of the particles increases. In a circular-path particle accelerator, particles move in a circle or substantially in a circle until they reach the desired energy.

An advantage of a circular-path particle accelerator compared to a linear particle accelerator is that it may be smaller than a linear particle accelerator of comparable power, since the circular-path of the particle allows continuous acceleration, whereas the particle acceleration achievable in a linear particle accelerator is limited by its length. Thus, circular-path particle accelerators may be more portable than linear particle accelerators.

Further, the use of high energy x-rays produced by a circular-path particle accelerator may allow inspection of objects of increased steel equivalent thickness to be achieved compared to the use of gamma rays produced by known radio-isotope sources. Furthermore, particle accelerators are not subject to the same regulations as radio-isotope sources, thus, they may be employed at increased water depths.

Circular-path particle accelerators may be provided with electrical power by means of a power supply unit, which power supply unit comprises one or more capacitors which charge and discharge at high frequency. A capacitor is a device composed of two conducting surfaces separated by a dielectric. Capacitors have the ability to store electrical power and rapidly release the power when required.

Capacitors which are employed to power circular-path particle accelerators may be liquid-filled capacitors, such as oil-filled capacitors, wherein the liquid is the dielectric. In such a capacitor, the liquid also functions as a cooling medium such that the two conducting surfaces are maintained at a temperature within a suitable operating range.

A disadvantage of liquid-filled capacitors is that they can only be operated in a vertical position with little leeway for deviation from the vertical axis. This may pose difficulties for off-shore operation. For example, if a liquid filled capacitor were to be arranged in a submersed apparatus there is no stable horizontal surface on which to place the capacitor. In such circumstances, operation of liquid-filled capacitors may cause exposure of one or both of the conducting surfaces which may lead to overheating. Overheating may lead to insufficient charging and/or failure of the capacitor.

It has now been found that by employing an electrical power supply comprising at least one solid state capacitor, it is possible to employ an x-ray source comprising a circular-path particle accelerator for the radiographic inspection of underwater objects.

According to the present invention there is provided an apparatus for radiographic inspection of an underwater object comprising:

an x-ray source for generating an x-ray beam for directing at an object under inspection; and

a power supply, for supplying electrical power to the x-ray source; wherein

the x-ray source comprises a circular-path particle accelerator, which circular-path particle accelerator comprises a circular-path particle chamber and an electromagnetic accelerator for accelerating electrons within the chamber, and

the power supply comprises at least one solid state capacitor for providing an alternating discharge current to drive the electromagnetic accelerator in the x-ray source.

According to a further aspect of the present invention there is provided a method for the radiographic inspection of an underwater object comprising:
positioning an x-ray source such that an x-ray beam may be directed at a first side of the object, wherein the x-ray source comprises a circular-path particle accelerator, which circular-path particle accelerator comprises a circular-path particle chamber and an electromagnetic accelerator for accelerating electrons within the chamber;
positioning a detector relative to the object so as to detect x-ray radiation from an x-ray beam passing through the object;
supplying electrical power to the x-ray source from a power supply, which power supply comprises at least one solid state capacitor for providing alternating discharge current to drive the electromagnetic accelerator in the x-ray source;
directing an x-ray beam from the source at the object;
detecting x-ray radiation which passed through the object.

Preferably, the detector is positioned at a second side of the object, such that the object is disposed between the source and the detector.

Preferably the x-ray beam generated by the x-ray source has an energy of at least 1 mega-electronvolt (MeV) (0.16021 picojoule). Preferably, the x-ray beam has an energy in the range 1 to 10 MeV, more preferably 2 to 7.5 MeV (0.320435 picojoule to 0.120163 picojoule).

Advantageously, it has been found that the use of an x-ray source comprising a circular-path particle accelerator allows inspection of underwater objects having a steel equivalent thickness of greater than 90 mm. Further, it has been found that a source of high energy x-rays comprising a circular particle accelerator may be operated in deep water. Thus, the present invention may be employed to carry out non-destructive inspection of, for example, deep water submarine pipelines.

The x-ray source may comprise a metal target for converting the accelerated electrons into x-ray radiation.

The x-ray source comprises a circular-path particle accelerator. The circular-path particle accelerator may be a Betatron. A Betatron is a particle accelerator in which the particles to be accelerated are electrons, and wherein the electrons are injected into a toroidal shaped vacuum chamber. An electromagnet accelerates the electrons in the vacuum around a circular-path. When electrons have achieved the desired energy (i.e. sufficient velocity) they are directed at a metal target. On impact with the metal target, the electrons lose energy; this energy is emitted from the Betatron in the form of a beam of high energy Bremsstrahlung x-rays.

Alternatively, the circular-path particle accelerator may comprise a cyclotron or a synchrotron.

The x-ray source is preferably contained in a water-tight housing. The housing should be made of a material or materials which prevent(s) the ingress of water, is/are chemically resistant and which is/are sufficiently mechanically robust to withstand the hydrostatic pressure at the water depth at which the object to be inspected is located. Suitably the housing may be made of metal, such as aluminium and/or titanium.

Preferably, the x-ray source is maintained at a temperature in the range 0-70° C. Maintenance of the source within such a temperature range may be achieved by circulating a coolant through the housing, for example, a cooling gas such as air or nitrogen. The gas may be cooled by indirect heat exchange with the body of water surrounding the water-tight housing, for example, by means of one or more heat exchangers.

For inspection of an underwater object, the x-ray source must be positioned such that the x-ray beam may be directed at a first side of the object. Preferably, the distance between the x-ray source and the object to be inspected is minimised, since the presence of water in between the x-ray source and the object will have the effect of reducing the intensity of the x-ray beam. Positioning of the x-ray source may be carried out by any suitable device. For example, where the object to be inspected is located in deep water (such as up to 3000 m), the x-ray source may be positioned using a remotely operated underwater vehicle, commonly referred to as an ROV.

A power supply supplies electrical power to the x-ray source. The power supply comprises at least one solid state capacitor. Suitably, the solid state capacitor is a capacitor wherein the dielectric is made of a solid material or a substantially solid material. In the event that the capacitor also contains an impregnant to prevent corrosion of the capacitor electrodes, the impregnant is also preferably made of a solid material or a substantially solid material. The at least one solid state capacitor may be a bank of capacitors arranged in parallel.

Suitable solid state capacitors for use in the present invention comprise a dielectric made from polypropylene. Preferably, the capacitor is constructed with a cylindrical winding element containing the capacitor terminals onto which is wound a metallized plastic polypropylene film. The metallic parts of the capacitor are preferably insulated from oxygen, humidity, and other environmental interference by housing the wound capacitor in a plastic case, and introducing a filler material (known as an impregnant) in the form of a solidified polyurethane (PUR) resin.

The at least one capacitor preferably charges and discharges at a frequency of at least 200 times per second.

The power supply may receive electrical power from a suitable source, which may be a 110 or 240 vAC source operating at 50 or 60 Hertz.

The power supply may comprise a switching circuit for periodically discharging electrical energy stored in the solid state capacitors to the electromagnetic accelerator in the x-ray source.

The power supply is preferably contained in a water tight housing, which may or may not be the same water tight housing in which the x-ray source may be disposed. The housing should be composed of a material or materials which prevent(s) the ingress of water, is/are chemically resistant and which is/are sufficiently mechanically robust to withstand the hydrostatic pressure at the water depth at which the object to be inspected is located. Suitably the housing may be composed of metal, such as, aluminium and/or titanium.

Preferably, the power supply and the x-ray source are contained in separate water tight housings which are in communication with each other by means of a suitable cable, for example, a reinforced marinised cable, which cable is capable of transferring electrical power from the power supply to the x-ray source. In this embodiment, the power supply is preferably spaced less than 10 m away from the x-ray source.

Preferably, the power supply is maintained at a temperature in the range 0-70° C. Maintenance of the power supply unit within such a temperature range may be achieved by circulating a coolant through the housing, for example, a cooling gas such as air or nitrogen. The gas may be cooled by indirect heat exchange with the body of water surrounding the water-tight housing, for example, by means of one or more heat exchangers.

Positioning of the power supply may be carried out by divers. Alternatively, the power supply unit may be positioned using a ROV. Preferably a single ROV is employed to position both the high energy x-ray source and the power supply unit.

Suitably, the radiographic inspection apparatus comprises a detector positioned to detect x-ray radiation from the x-ray beam which passes through the object being inspected.

In use, the x-ray source directs a beam of x-rays at one side of the underwater object to be inspected. A portion of the x-ray radiation from the x-ray beam will be absorbed by the object and a portion will pass through the object. The detector detects the x-ray radiation which passes through the object. Thus, the object may be disposed between the source and the detector. Ideally, the source and detector are disposed on either side of the object. However, if reflective surfaces are employed then alternative configurations may be possible.

The detector may comprise an x-ray sensitive material for recording an image of the object. Alternatively, the detector may convert x-ray radiation received at the detector into electrical signals for conversion into a digital image of the object.

The detector may be, for example, a direct or indirect Flat Panel Detector (FPD). Alternatively, the detector may comprise a computed radiography system, such as a phosphor imaging plate.

Where the detector converts x-ray radiation received at the detector into electrical signals for conversion into a digital image of the object, such a digital image output from the detector may be received by an image unit, such as a computer for further processing and storage, which may be located at the surface of the body of water. The means for transmitting the digital image to an image unit may comprise a telemetry link. Suitable telemetry links may include a radio-signal, an infra-red signal, or a marinised fibre optic cable. Where the digital image is transmitted to a computer, software may be employed to further process the data into a viewable image of the portion of the underwater object at which a beam of x-rays was directed.

The detector is preferably contained in a water-tight housing. The housing should be composed of a material or materials which prevent(s) the ingress of water, is/are chemically resistant and which is/are sufficiently mechanically robust to withstand the hydrostatic pressure at the water depth at which the object to be inspected is located. Suitably the housing may be composed of metal, such as, aluminium and/or titanium.

Power may be supplied to the detector by means of a power supply which is independent of the power supply employed to supply power to the x-ray source. A power supply employed to supply power to the detector may be contained in a water-tight housing, which may or may not be the same housing in which the detector is disposed.

For inspection of an underwater object, the detector may be positioned at the opposite side from the x-ray source, i.e. with the object disposed between the source and the detector. Preferably, the distance between the detector and the object to be inspected is minimised, since the presence of water in between the detector and the object will have the effect of reducing the intensity of the x-rays which are detected by the detector, which may result in the formation of an inferior image of the object. Positioning of the detector may be carried out by divers. Alternatively, the detector may be positioned using an ROV.

The radiographic inspection apparatus may comprise a control unit which may control the x-ray source, the power supply to the x-ray source and/or the power supply to the detector.

In a preferred embodiment of the present invention, the x-ray source and the detector are both mounted on a deployment frame which allows the source and the detector to be positioned at opposite sides of the object and be simultaneously moveable such that, after inspection of one part of the object has been carried out, the x-ray source and the detector can be moved together such that another part of the object, or a different object, may be inspected. For example, where the apparatus or method are to be used to inspect a sub-marine pipeline, the deployment frame may be capable of moving both the x-ray source and the detector in either a circumferential motion around the pipe, and/or in a longitudinal motion, i.e. along the length of the pipe.

Where an underwater object to be inspected is buried or partially buried, excavation or partial excavation of the object may be required before carrying out inspection of the object using the present invention. For example, an underwater pipeline may require excavation such that the underside or sides of the pipeline can be accessed and inspected according to the present invention. Excavation or partial excavation may be carried out using dredging equipment. Such equipment may be operated by divers or by an ROV.

The apparatus according to the present invention may be controllable by means of a control room, situated at a location remote from the object to be inspected, and in communication with the apparatus by means of a telemetry link. For example, the control room/panel may be situated on a surface vessel or platform.

The images generated using the apparatus or by performing the method of the present invention may provide structural information on the inspected object. For example, the present invention may provide indications of erosion or corrosion, the presence of any hydrate plugging and/or the presence of foreign bodies.

The present invention may be employed to carry out non-destructive inspection of many underwater structures. For example, the present invention may be employed to inspect underwater pipelines, manifolds, risers, termination devices, structural components, well-heads, platform legs, caissons and/or pilings.

The present invention will now be illustrated by the following non-limiting examples and with reference to Figures, in which:

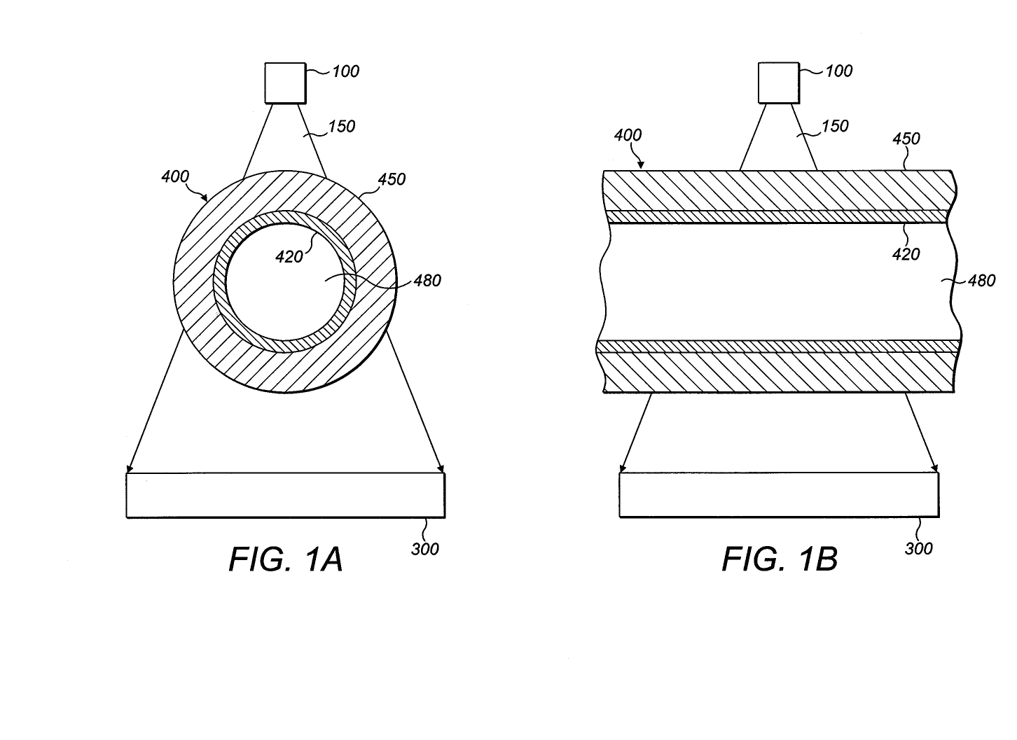

FIG. 1A is an end cross-sectional view of an x-ray inspection apparatus arranged to inspect a pipeline.

FIG. 1B is a side cross-sectional view of the x-ray inspection apparatus of FIG. 1A.

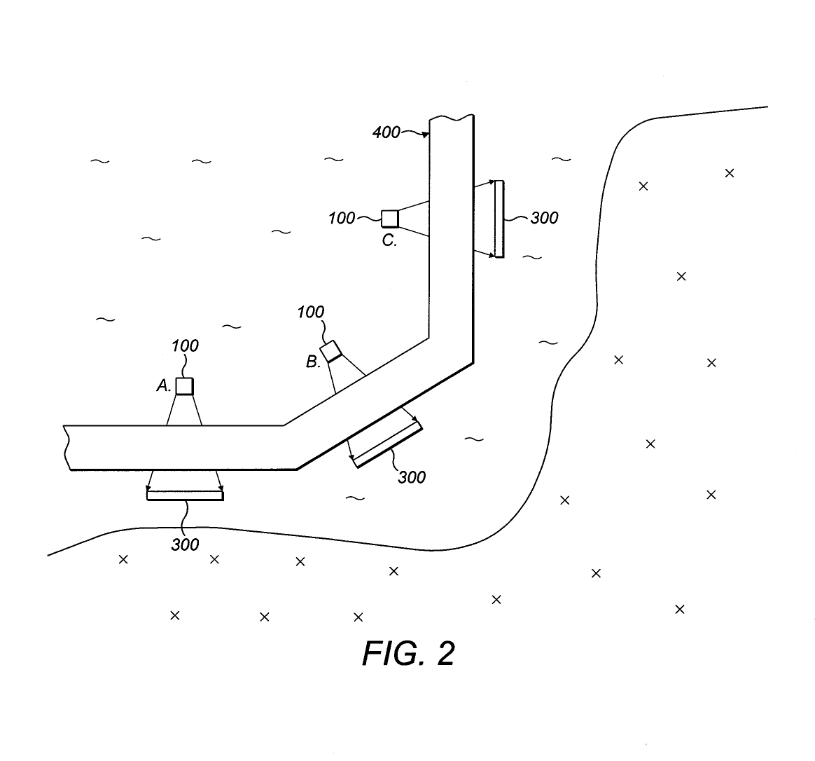

FIG. 2 is a side view of a subsea pipeline illustrating the x-ray inspection apparatus of FIGS. 1A and 1B in three different positions.

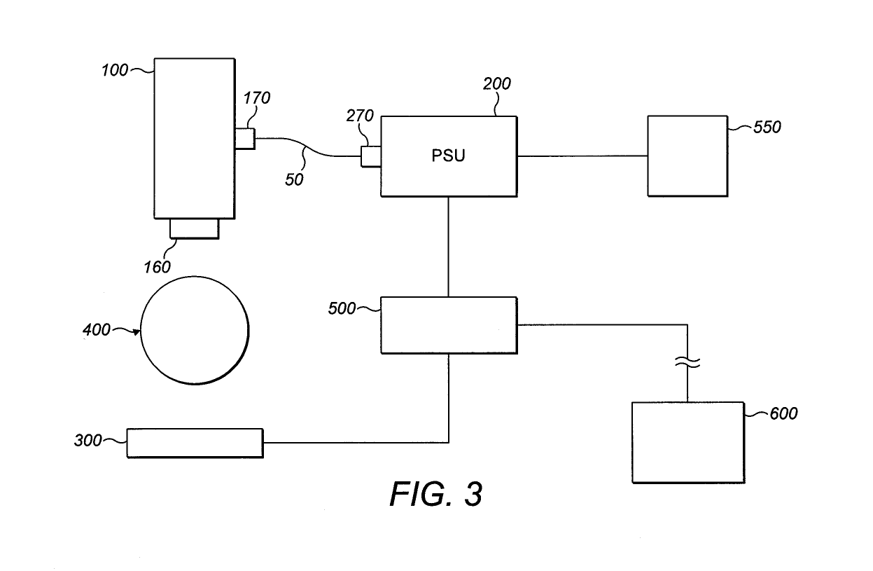

FIG. 3 is a schematic diagram of an x-ray inspection apparatus in accordance with the invention.

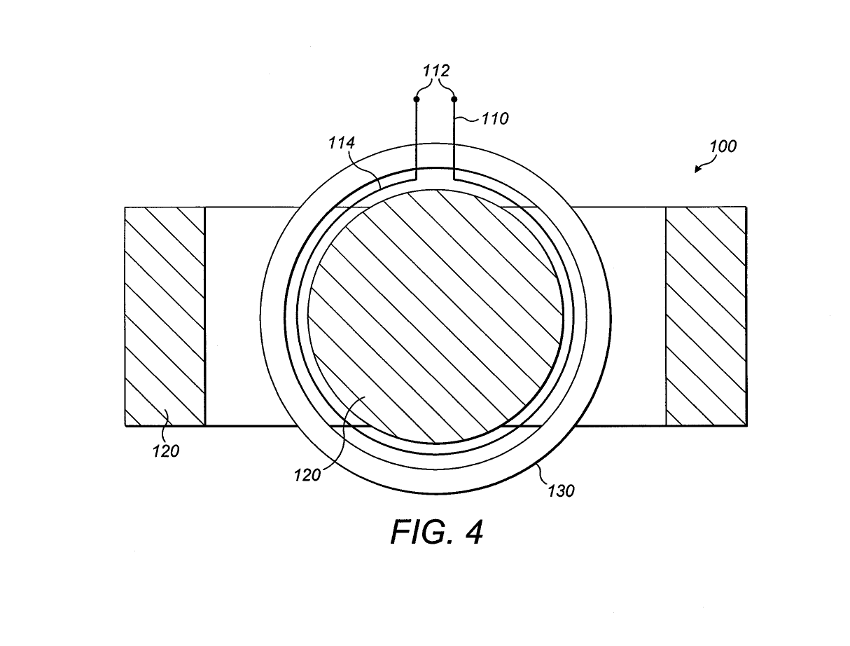

FIG. 4 is a cross-sectional view of a Betatron electron particle accelerator for use in the x-ray inspection apparatus of FIG. 3.

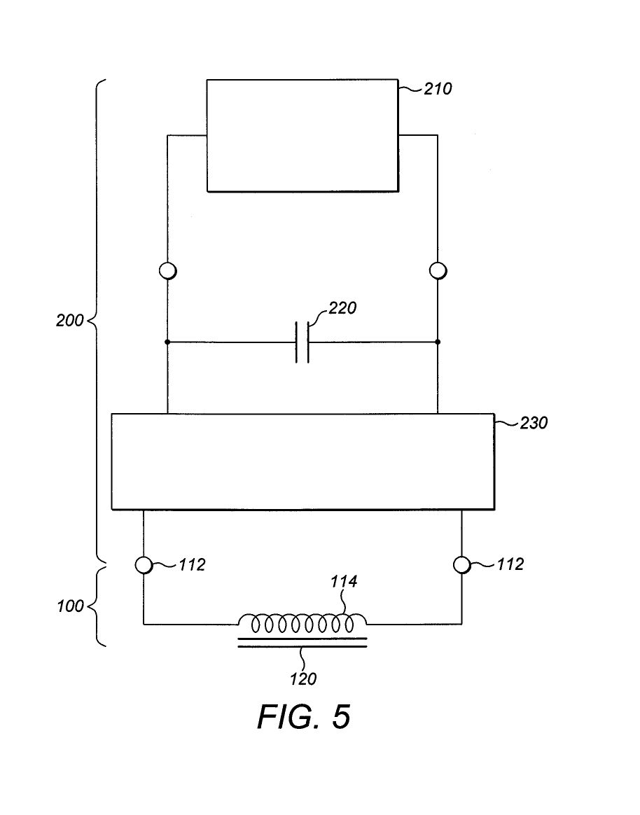

FIG. 5 is a diagram of a driving circuit arranged to couple with an electromagnet of the Betatron electron particle accelerator.

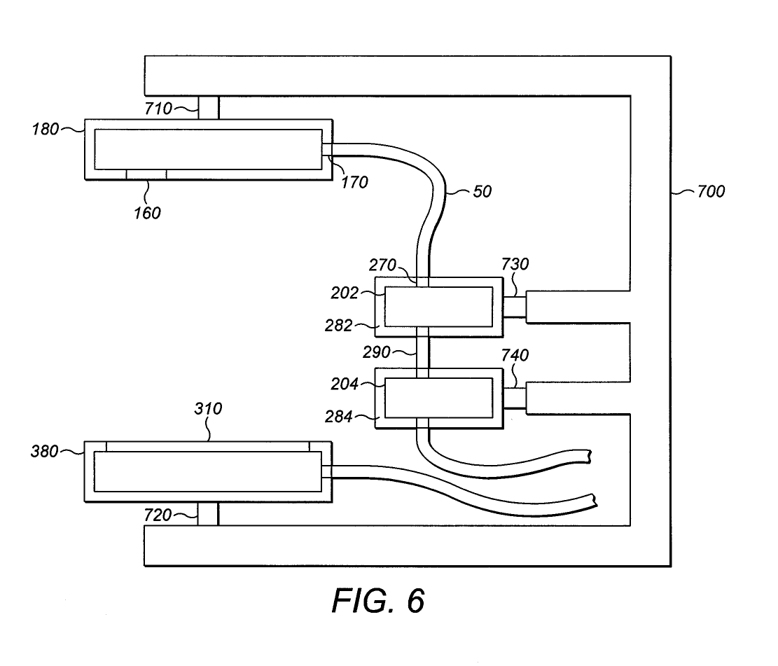

FIG. 6 is an illustration of an alternative x-ray inspection apparatus in accordance with the invention assembled in a support frame.

Referring to FIGS. 1A and 1B, there is shown a basic arrangement of an x-ray inspection apparatus including an x-ray radiator 100 which provides a source of high-energy x-rays, and an x-ray radiation detector 300. The apparatus is arranged to inspect an object such as a pipeline 400 which may be an undersea pipeline located at depths of up to 3000 meters. Accordingly, the x-ray inspection apparatus is designed to be submersible up to the depth of the pipeline to be inspected. The pipeline 400 may be a steel flow-line, a transit line, an export line, a trunk line, an injection line, or various types of riser.

Typically, the pipeline will be in the form of a steel pipe 420 with a suitable marine protective coating 450 to protect the pipe 420 from corrosion and damage. The pipe 420 may have a wall thickness in the range of 5 mm to 40 mm and the outside diameter of the pipe may range in size from 10 cm to 60 cm.

The protective coating 450 may be up to 10 cm thick and typically would be made from FBE (fusion bonded epoxy), PP (polypropylene), PU (polyurethane) and 3LPP (three layer polypropylene). Alternatively, the protective coating 450 may be formed of concrete up to 10 cm thick. The x-ray inspection apparatus can be arranged to account for the protective coating 450 since removal of the coating or any other surface preparation of the pipeline can be difficult at high depths.

The fluid medium 480 inside the pipeline 400 may be various forms of oil, gas, hydrates, waxes and/or water, for example.

The x-ray radiator 100 operates to generate a controlled dose of x-ray radiation in an x-ray beam 150 directed at the object under inspection, which in this case is the pipeline 400. The x-ray radiator 100, also known as a radiator head, ideally produces high energy radiation of up to 7.5 MeV with a dose rate of approximately 5 Röntgen per minute (R/minute) at 1 meter in air.

It is recognized that water is very attenuating and will reduce the dose rate of the x-ray radiator as the distance between the radiator 100 and the pipeline 400 (the so-called stand-off distance) is increased. The effective stand-off distance can be minimised by appropriate arrangement of the x-ray radiator 100 and the pipeline 400, or by displacing the attenuating water with a more transmissive material in the stand-off space. A suitable transmissive material might be polyethylene, polypropylene, or polyurethane.

The x-ray radiation detector 300 is a flat panel which receives the x-ray radiation from the x-ray beam 150 passing through the object or pipeline 400. Due to the various absorption characteristics of the materials in the object, and the extent to which the x-ray radiation passes through those materials, the quantity of x-ray radiation received at the detector 300 will vary across the surface of the flat panel. Typically, the flat panel will have a square or rectangular shaped detection surface which is arranged to face the x-ray radiator 100. The x-ray radiation received at the surface of the panel will thus vary in both the width-wise and depth-wise dimensions. The x-ray detector 300 operates to spatially record the received radiation over the dosage period such that a radiological image of the object or pipeline 400 can be reproduced. The x-ray radiation detector 300 might be further improved by replacing the flat panel with a curved panel to match the curvature of the pipe or other object under inspection.

Referring now to FIG. 2, there is shown a subsea pipeline 400 extending in a horizontal direction, around a corner section, to a vertical direction. The x-ray inspection apparatus 100, 300 is illustrated in 3 different inspection locations on the pipeline 400 labelled A, B, and C. The pipeline is shown clear of the seabed in FIG. 2. If the pipeline is lying on the seabed or is buried slightly below the seabed then it may be necessary to dredge or excavate around the portion of the pipeline requiring inspection.

The x-ray radiator 100 and detector 300 are capable of being mounted on a manual or motorized support frame. The manipulator will be positioned by divers or remotely operated vehicles (ROVs) to the pipeline 400. The manipulator allows the radiator 100 and the detector 300 to be moved together in both a circumferential and axial motion along the pipeline to produce the required radiographic images. For example, the manipulator may allow the x-ray inspection apparatus 100, 300 to be positioned on a horizontal portion of the pipeline as shown by label A, an inclined portion of the pipeline 400 as shown by label B, or a vertical portion of the pipeline as show by label C.

Due to the different inclines of the pipeline, and the requirement to inspect at different positions around the circumference of the pipeline, the x-ray inspection apparatus should preferably be able to operate in 360 degrees of orientation.

Inspection by the x-ray inspection apparatus is preferably performed on straight sections or on sections having a minimum radius of curvature equivalent to about 5 times the nominal diameter of the pipeline.

As an alternative to pipelines, the object under inspection could be any other structure suitable for inspection such as a manifold or a valve.

Referring now to FIG. 3, there is shown a schematic diagram of an x-ray inspection apparatus. The apparatus comprises an x-ray radiator head 100, a power supply unit 200, and a digital x-ray detector 300.

The x-ray radiator head 100 generates high-energy x-rays by means of high speed electron bombardment of a target plate made from a metal such as tungsten, molybdenum, tantalum or copper. The high speed electrons must be accelerated to a high enough speed to produce x-ray photons of sufficient energy to pass through some of the object under inspection in order to create a radiographic image at the detector 300. To achieve this, the x-ray radiator head 100 comprises a circular-path charged-particle accelerator. The accelerating mechanism for the accelerator is an electric field produced by a changing magnetic flux from an electromagnet. The electrons are accelerated in a toroidal-shaped vacuum chamber until they reach a high enough speed for the required x-ray energy. A particle accelerator of this type is commonly known as a Betatron.

X-rays produced by the x-ray radiator head 100 are directed through the x-ray window 160 located on the outer housing of the radiator head facing the object under inspection 400.

X-ray radiation that passes through the object 400 is detected by the digital detector 300. The digital detector 300 uses digital x-ray sensors in place of traditional film to provide a near real-time radiographic image of the object under inspection 400. This technique is sometimes referred to as direct radiography (DR). The detector 300 is a flat panel detector which includes a square-shaped flat detection panel comprising a two-dimensional array of x-ray sensors. The detector 300 includes circuitry to periodically read and reset the electric signals from the sensor array, and provide a digital output representative of a series of detected image frames.

The detection panel is designed as an indirect amorphous silicon (a-Si) flat panel detector (FPD). A scintillator made from caesium iodide (CsI) or gadolinium oxysulfide (Gd2O2S) is arranged on an upper layer of the detector 300 to receive x-ray radiation passing through the object 400, and converts the x-ray photons to photons of visible light. Because of this conversion, the a-Si FPD detector is known as an indirect imaging device. The resulting visible light photons are channeled through the a-Si photodiode layer where it is converted to an electrical signal. The electrical signal is then read out by thin film transistors (TFTs) or fibre-coupled CCDs (charged coupled device) to form a digital signal of the image. If lower energy x-rays are employed by the x-ray inspection system then it may be preferable to use a scintillator layer made from caesium iodide due to its efficiency at lower x-ray energies.

Alternatively, the flat panel detector can be implemented as a direct FPD in which x-ray photons are converted directly into an electrical charge. The outer layer of the flat panel in this design is typically a high-voltage bias electrode. X-ray photons create electron-hole pairs in an amorphous selenium (a-Se) layer. The transit of these electrons and holes depends on the potential of the bias voltage charge. As the holes are replaced with electrons, the resultant charge pattern in the selenium layer is read out by a TFT or active matrix array.

As a further alternative, the digital detector 300 could be replaced by a non-real-time detector system such as a computed radiography system or a traditional film-based detector. In computed radiography (CR), the x-ray radiation incident on the detector is recorded on an image plate made of photostimulable phosphor. The image plate is housed in a cassette which is specifically designed for reading by a computer radiography scanner. X-ray radiation incident on the photostimulable phosphor is captured and stored by the phosphor. Subsequently, the cassette is removed from the x-ray inspection apparatus and placed in the CR scanner which stimulates the phosphor on the image plate with a scanning laser, and reads the light emitted from activated phosphor to build up a radiographic image.

The x-ray inspection apparatus further comprises a control unit 500. The control unit 500 performs a variety of control functions for the inspection apparatus including controlling powering up of the x-ray radiator 100 via the power supply 200, and timing and synchronising the dosage of x-ray radiation with the detection by the detector 300. The control unit 500 may also perform various safety functions such as shutting-down the power supply or the radiator in the event of overheating or unexpected operation.

The control unit 500 also contains an imaging section for receiving the digital image output of the digital detector 300. The digital image output may be further processed by the imaging section of the control unit to enhance the images received, to compress the images, and/or to log and store the images for further processing. The x-ray inspection apparatus may include a remote operator unit 600 located at the surface or the sea. Images received, processed or stored by the control unit 500 may be retrieved by the remote operator unit 600, or automatically transmitted to the remote operator unit 600.

Analysis of the image data from the detector by the imaging section of the control unit or by the remote operator unit, can provide control feedback such that the control unit is able to adapt the x-ray inspection apparatus to improve the x-ray inspection parameters of the system. Such control feedback can be in real-time as the detection is occurring, or non-real-time so that subsequent measurements can be improved.

Referring now to FIG. 4, there is shown a cross-section view of the Betatron electron particle accelerator used to generate the high velocity electrons in the x-ray radiator 100 of FIG. 3. The Betatron comprises an acceleration chamber 130 for the electrons, and an electromagnet for providing the modulating electric field to accelerate the electrons to a desired energy. The electromagnet is formed by a magnetic core 120 made from iron, and one or more coils or windings 114 surrounding a central cylindrical portion of the magnetic core. The coils 114 are made from conductive copper wires and operate to deliver an alternating current from an alternating current source in the power supply 200 via the terminals 112 and supply lines 110. The alternating current source is preferably operated at a frequency of approximately 200 Hz using a bank of high frequency capacitors. The bank of high frequency capacitors may consist of 6 or 8 capacitors arranged in an electrically parallel configuration. Each capacitor may be a metallized plastic polypropylene capacitor with a capacitance of 20 microfarads (μF). The alternating current creates an accelerating flux in the magnetic core which in turn produces an accelerating electric field across the acceleration chamber 130.

The acceleration chamber is a toroidal-shaped tube made from glass, which defines a vacuum chamber in which electrons can be accelerated by the changing flux in the magnetic core 120.

The Betatron electron accelerator includes an injection device (not shown) for injecting electrons into the acceleration chamber 130. The injected electrons are accelerated in substantially circular orbital paths within the acceleration chamber 130. Once they have attained a suitable velocity, they are deflected from the chamber towards a metal target (not shown) which converts the high-velocity electrons into x-rays.

A high-voltage transformer may be involved in the injection of the electrons into the acceleration chamber 130, and can be physically connected to and part of the chamber. Contractor and expansion coils may be employed to control the injection and deflection of electrons in the circular path. The contractor coil carries a pulse of high current, and is triggered at the beginning of the acceleration cycle, at approximately the same time as a high-voltage pulse is applied to a cathode (filament) in the accelerating chamber. The triggering of the contractor coil assists in the capture of the maximum number of electrons within the accelerator tube by setting up an initial magnetic field, before the main electromagnet achieves sufficient flux to hold the electrons in orbit.

The expansion coil also carries a pulse of high-current, and is triggered later in the acceleration cycle, when the electrons have gained sufficient energy. This coil disturbs the electromagnet's magnetic field, allowing the electrons to spin outwards towards the metal target.

Referring again to FIG. 3, the x-ray inspection apparatus includes a power supply unit 200 which operates to provide a suitable alternating supply current to the x-ray radiator 100 via a power cable 50. The power cable 50 may also provide other voltage supplies to the x-ray radiator 100 to provide power to the electron generation, injection, and deflection circuitry of the Betatron. Control signalling can also be provided over the power cable 50 to control timings and performance parameters of the x-ray radiator 100. Ideally, the control signalling originates from the control unit 500 via power supply unit 200. Alternatively, the control signalling may be applied to the x-ray radiator via a separate signalling cable from the control unit 500. Feedback signalling from the x-ray radiator to the control unit 500 may also be sent over the power cable 50.

The x-ray radiator 100 and the power supply unit 200 may include suitable subsea interfaces 170, 270 for connecting (and disconnecting) the power cable 50, and the power cable may be of a type suitable for subsea operation down to depths of 3000 meters.

The power supply unit 200 may comprise an input for receiving electrical power from a suitable standard source 550. For example, the standard source 550 may be a 110 or 240 volt source operating at 50 or 60 Hertz.

The power supply unit 200 includes circuitry for cleaning up the signal from the standard source 550 to ensure that electrical power is available at the correct set of voltages and with minimal disruption or spikes to other operations of the x-ray inspection apparatus.

One of the important functions of the power supply unit 200 is to provide an alternating current source to the Betatron electron accelerator. FIG. 5 illustrates schematically the circuitry provided in the power supply unit 200 to power the Betatron.

Referring to FIG. 5, there is shown the power supply circuitry from the power supply unit 200, and elements of the Betatron that are coupled to the power supply circuitry via the power cable 50. The power supply circuitry of the power supply unit 200 includes a voltage drive circuit 210, a capacitive element 220, and a switching circuit 230 in the form of a thyristor arrangement. The voltage drive circuit 210 supplies a high voltage DC power to charge up the capacitive element 220, and to power the switching circuit 230.

Once charged up, the capacitive element 220 provides the driving alternating current source for the Betatron. At the beginning of the acceleration cycle, the switching circuit 230 discharges the capacitive element 220 via the terminals 112 to the flux coils 114 of the electromagnet 114, 120 of the Betatron. Thus, the energy stored in the capacitive element is transferred to the Betatron to accelerate the electrons in the acceleration chamber. With the capacitive element 220 discharged, the capacitor voltage falls to zero. This coincides with the current through the flux coils 114 being at a maximum. The inductance of the electromagnet then continues to drive the current, in the absence of any driving voltage from the capacitive element 220. This results in the capacitive element 220 being recharged, albeit in the opposite polarity with the assistance of the switching circuit 230.

The capacitive element 220 then discharges current in the opposite direction to again transfer energy to the Betatron, and finally the capacitive element 220 is re-charged by the electromagnet 114, 120 at the end of the cycle. The reversal of the polarity is not an issue, as the thyristors in the switching circuit 230 are arranged to correctly apply the voltage to the flux coils via the terminals 112, irrespective of the polarity of the capacitor element 220. Losses that occur in the acceleration cycle due to heat, for example, are replenished by the voltage drive circuit 210.

The capacitive element 220 has special characteristics that enable it to provide the alternating current source for the Betatron electromagnet. These characteristics include a high capacitance to store sufficient energy to power the Betatron, the ability to charge and discharge at the rate of approximately 200 times per second (same as the current source frequency of 200 Hertz), and the ability to dissipate heat that is likely to build up due to the fast energy transfers that occur during operation.

The capacitive element 220 is implemented as a bank of 6 to 8 separate 20 μF capacitors arranged in parallel to provide higher capacitance. The capacitors are designed to handle large discharge currents as well as normal and reverse polarities for alternating current and voltage operation. Suitably, the capacitors are metallized plastic polypropylene capacitors. Each capacitor has a dry construction in which the capacitor is filled with a non-liquid material. Specifically, each capacitor comprises a dielectric made from polypropylene, and is constructed with a cylindrical winding element containing the capacitor terminals onto which is wound a metallized plastic polypropylene film. The metallic parts of the capacitor are insulated from oxygen, humidity, and other environmental interference by a housing made from plastic. The wound part of the capacitor containing the electrodes and the dielectric are placed in the plastic case, and a non-liquid filler material is introduced to encapsulate the electrodes and dielectric. The non-liquid filler can be formed from a solidified polyurethane (PUR) resin. The filler also acts to protect the capacitor elements from oxygen, humidity, and other environmental interference. The shape of each capacitor is typically a cylinder with the terminals located at the central axis. The dimensions may be in the order of 100 mm for the capacitor diameter and 100 mm for the capacitor length.

Other suitable capacitor constructions could be employed in place of the metallized plastic polypropylene capacitor provided they enable movement of the capacitor in a deep sea environment.

The use of solid state capacitors as the capacitive element to drive the Betatron electromagnet has several advantages. For example, the solid state capacitors allow the power supply unit to be used sub-sea where there is no stable horizontal surface on which to place the capacitor. Further, the solid state capacitors allow the power supply unit to be orientated in multiple directions. This allows the power supply unit 200 to move together with the x-ray radiator 100.

Referring back to FIG. 2, it can be seen that the repositioning of the x-ray radiator 100 and detector 300 at positions A, B, and C requires re-orientation of the x-ray inspection apparatus. Additional measurements around the circumference of the pipeline 400 further accentuates this orientation requirement. Enabling the power supply unit 200 to move together with the x-ray radiator 100 and the detector 300 increases maneuverability of the x-ray inspection apparatus, reduces the chances of tangling of the power cable 50, and enables easier deployment.

Referring now to FIG. 6, there is shown an alternative arrangement of the x-ray inspection apparatus in accordance with the invention. The inspection apparatus includes a support frame 700, and marinisation of the inspection apparatus is further illustrated.

The elements of the x-ray inspection apparatus of FIG. 3 are also illustrated in FIG. 6. Specifically, the inspection apparatus includes an x-ray radiator 100, a power supply unit 200, and an x-ray detector 300. X-ray radiator 100 has been sealed in a water-tight enclosure 180 suitable for protecting the radiator down to the depth of 3000 meters. The detector 300 is also sealed in a similar water-tight enclosure 380 with a suitable window material 310 to allow detection of received x-ray radiation. The power supply unit 200 has been divided 202, 204 into 2 sealed enclosures 282, 284 which are coupled together by a suitable electrical connection 290.

The support frame 700 enables all three component 100, 200, 300 of the x-ray inspection apparatus to be moved together. Each component is coupled to the support frame 700 by a releasable coupling 710, 720, 730, 740. The releasable couples and the frame 700 may also permit relative movement between the components.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. For example, the circular-path particle accelerator could be modified to accelerate electrons in an elliptical path rather than a purely circular path.

1. An apparatus for radiographic inspection of an underwater object comprising:
an x-ray source for generating an x-ray beam for directing at an object under inspection; and
a power supply, for supplying electrical power to the x-ray source;
wherein the x-ray source comprises a circular-path particle accelerator, which circular-path particle accelerator comprises a circular-path particle chamber and an electromagnetic accelerator for accelerating electrons within the chamber, and
the power supply comprises at least one solid state capacitor for providing an alternating discharge current to drive the electromagnetic accelerator in the x-ray source.

2. An apparatus according to claim 1, wherein the x-ray source further comprises a metal target for converting the accelerated electrons into x-ray radiation.

3. An apparatus according to claim 1 or 2, wherein the x-ray source is a Betatron.

4. An apparatus according to claim 1, wherein the x-ray source is contained in a water-tight housing.

5. An apparatus according to claim 1, wherein the power supply is contained in a water-tight housing.

6. An apparatus according to claim 1, wherein the power supply further comprises a switching circuit for periodically discharging electrical energy stored in the solid state capacitors to the electromagnetic accelerator in the x-ray source.

7. An apparatus according to claim 1, wherein the power supply further comprises an input for receiving power from an electrical power source.

8. An apparatus according to claim 1, wherein the at least one solid state capacitor comprises a bank of solid state capacitors.

9. An apparatus according to claim 1, wherein the at least one solid-state capacitor comprises a capacitor with a dielectric material that is substantially solid.

10. An apparatus according to claim 1, further comprising a detector positioned to detect x-ray radiation from the x-ray beam which passes through the object.

11. An apparatus according to claim 10, wherein the detector comprises an x-ray sensitive material for recording an image of the object.

12. An apparatus according to claim 10, wherein the detector converts x-ray radiation received at the detector into electrical signals for conversion into a digital image of the object.

13. An apparatus according to claim 10, wherein the detector is contained in a water-tight housing.

14. An apparatus according to claim 1, further comprising a control unit for controlling the x-ray source and/or the power supply.

15. An apparatus according to claim 1, wherein the x-ray beam has an energy of at least 1 MeV.

16. A method for the radiographic inspection of an underwater object comprising:
positioning an x-ray source such that an x-ray beam may be directed at a first side of the object, wherein the x-ray source comprises a circular-path particle accelerator, which circular-path particle accelerator comprises a circular-path particle chamber and an electromagnetic accelerator for accelerating electrons within the chamber;
positioning a detector relative to the object so as to detect x-ray radiation from an x-ray beam passing through the object;
supplying electrical power to the x-ray source from a power supply, which power supply comprises at least one solid state capacitor for providing alternating discharge current to drive the electromagnetic accelerator in the x-ray source;
directing an x-ray beam from the source at the object;
detecting x-ray radiation which passes through the object.
